(19) United States
(12) Patent Application Publication
(10) Pub. No.: US 2025/0327748 A1
(43) Pub. Date: Oct. 23, 2025

(54) SPECTRAL IMAGING INSPECTION METHOD AND SYSTEM USING ULTRA-WIDEBAND TUNABLE LIGHT SOURCE

(71) Applicant: iiSM Inc., Sejong (KR)

(72) Inventors: Il Seung YANG, Sejong (KR); Yun Mi BAE, Sejong (KR); Yu Sic KIM, Sejong (KR); Youn Jin KIM, Daejeon (KR); Chang Hyun Bae, Sejong (KR); Hueng Khon Kim, Rowland Heights (KR)

(73) Assignee: iiSM Inc., Sejong (KR)

(21) Appl. No.: 18/804,772

(22) Filed: Aug. 14, 2024

(30) Foreign Application Priority Data
Apr. 22, 2024 (KR) 10 2024 0053659

(51) Int. Cl. G01N 21/39; G01N 21/33; G01N 21/3563; G01N 21/95

(52) U.S. Cl. CPC G01N 21/39; G01N 21/33; G01N 21/3563; G01N 21/9501

(57) ABSTRACT

Spectral imaging inspection method and system for selecting light having a specific wavelength in ultra-wideband wavelengths. A light source radiates light having a specific wavelength band, and a filter unit allows light having a specific wavelength in the specific wavelength band of the light radiated from the light source to be passed through it. A detection unit detects an image of the object with respect to the specific wavelength of the light passed through the filter unit and radiated to the object. The specific wavelength band includes a first wavelength, a second wavelength, and a third wavelength, wherein the light of the first wavelength is reflected by the object, only part of the light of the second wavelength penetrates the object, and the light of the third wavelength penetrates the object, and the third wavelength is a wavelength band of short wave infrared rays of 1000 nm or more.

### CROSS-REFERENCE TO RELATED APPLICATION

This application claims priority to Korean Patent Application No. 10-2024-0053659, filed Apr. 22, 2024, the entire disclosure of which is incorporated herein by reference.

### TECHNICAL FIELD

The present invention relates to spectral imaging inspection method and system for selecting light having a specific wavelength in ultra-wideband wavelengths from which desired information can be obtained.

### BACKGROUND

In a process of manufacturing a product, a procedure for checking whether a defect has occurred in the product is required. In order to check whether the product is defective, it is necessary to inspect the inside of the product as well as the appearance of the product. Typically, light having a wavelength in the visible region is used to inspect the appearance of a product, and X-rays are used for see-through inspection of the product. Since X-rays are high-energy radioactive waves having a wavelength much shorter than that of ultraviolet rays (wavelength in the range of 10 nm (10×10⁻⁹ m) to 0.01 nm), there is a problem that large-scale facilities and various safety measures and experts are required, resulting in significant costs and efforts.

For example, various defects may occur in a manufacturing process of a semiconductor wafer. In a process of depositing a thin film of a semiconductor, various types of defects may occur in the semiconductor wafer, such as a void in the semiconductor, a peeled oxide film on the surface of the semiconductor, or a crack in the semiconductor. Accordingly, in order to check defects of a semiconductor, it is necessary not only to inspect the appearance of the semiconductor but also to inspect the inside of the semiconductor.

Typically, inspection of the appearance of a semiconductor is performed using light having a wavelength in the ultraviolet region, and inspection of the inside of a semiconductor is performed using X-rays that can see through the wafer. Since X-rays are a light source with high energy, it is required to appropriately adjust the intensity of X-rays. Accordingly, in order to use X-rays, relatively large equipment and space and various safety measures and experts related to radioactive ray are required. As stated above, since inspection of the inside of a semiconductor using X-ray equipment requires significant costs and efforts, inspection of the appearance of a semiconductor using visible rays and inspection of the inside of a semiconductor using X-rays are in reality performed separately.

In a spectral imaging method of the conventional art, light is divided into bands of various wavelengths using a spectrometer such as a diffraction grating in front of a hyperspectral camera. Since, in the conventional art, a complicated spectrometer is mounted in front of a detector, there are problems that the detection side equipment is large, and the range of the wavelengths of the light that can be selected is limited.

In another spectral imaging method of the conventional art, spectral imaging is carried out by radiating light of a specific wavelength to a target object without installing a spectrometer at the detector side. In this case, there is an advantage that spectral imaging is possible using only a wavelength from which desired information can be obtained. However, in the conventional art, light having various wavelengths is not used because only light of a specific wavelength is radiated, and a detector can detect only a relatively narrow wavelength band in a range of, for example, 200 to 1100 nm or 900 to 1700 nm. Given this, there is a limitation that it is not possible to simultaneously detect light of a wide wavelength band.

### SUMMARY

### Problem to be Solved

Unlike the conventional art, the present invention provides a method for performing-see-through inspection of the inside of an object without using X-rays according to the properties of the material. For example, in the case of a semiconductor wafer made of silicon, inspection of the inside of the semiconductor wafer may be performed by seeing through the semiconductor wafer using a long wavelength of 1000 nm or more (short wave infrared rays). That is, according to the spectral imaging method and system of the present invention, appearance inspection and see-through inspection of an inspection target may be simultaneously performed by one system by using various wavelengths depending on the inspection target.

The object of the present invention is to provide spectral imaging method and system capable of simultaneously obtaining, by one system, various pieces of information such as information on the appearance and the inside of an object being inspected using an ultra-wideband tunable light source and a camera capable of detecting light of a wide wavelength band.

### Means for Solving the Problem

A spectral imaging inspection system according to an example of the present invention for solving the above-mentioned technical object comprises: a tunable light source unit, comprising a light source for radiating light having a specific wavelength band, and a filter unit for allowing light having a specific wavelength in the specific wavelength band of the light radiated from the light source to be passed through it; a holding unit for holding an object; and, a detection unit for detecting an image of the object with respect to the specific wavelength of the light passed through the filter unit and radiated to the object. The specific wavelength band includes a first wavelength, a second wavelength, and a third wavelength, wherein the light of the first wavelength is reflected by the object, only part of the light of the second wavelength penetrates the object, and the light of the third wavelength penetrates the object, and the third wavelength is a wavelength of short wave infrared rays of 1000 nm or more.

The filter unit may comprise at least one wheel unit, the wheel unit may comprise two wheel filters, the wheel filters may be circular plates, and comprise a plurality of filters arranged in a circular shape on an edge portion thereof, and each of the plurality of filters may allow light of a different wavelength to be passed through it.

The wheel filter may further comprise a blank slot not comprising a filter on the edge portion.

For the purpose of allowing a specific wavelength in the specific wavelength band of the light radiated from the light source to be passed through the filter unit, each of the two wheel filters of the filter unit may independently rotate to select, in each of the two wheel filters, the blank slot or any one of the plurality of filters through which the light is to be passed, and when any one of the plurality of filters is selected in the wheel filter, the filter is capable of rotating such that an incident angle of the light with respect to the filter is adjusted, wherein light of a different wavelength may be passed through the filter depending on the incident angle of the light.

The incident angle of the light with respect to the filter may be equal to or greater than 0° and less than 90°.

The object may be a semiconductor wafer, the first wavelength may be included in a wavelength band of ultraviolet rays or visible rays, and the second wavelength may be included in a wavelength band of near infrared rays.

The light source for radiating light having ultra-wideband wavelengths may be a lamp or a laser.

The detection unit may be an image sensor capable of detecting visible rays, near infrared rays, and short wave infrared rays.

A spectral imaging inspection method according to an example of the present invention comprises: holding an object in a holding unit; radiating, from a light source, light having a specific wavelength band; passing, through a filter unit, light having a specific wavelength in the specific wavelength band of the light radiated from the light source; and, detecting, with a detecting unit, an image of the object with respect to the specific wavelength of the light passed through the filter unit and radiated to the object. The specific wavelength band includes a first wavelength, a second wavelength, and a third wavelength, wherein the light of the first wavelength is reflected by the object, only part of the light of the second wavelength penetrates the object, and the light of the third wavelength penetrates the object, and the third wavelength is a wavelength band of short wave infrared rays of 1000 nm or more.

The filter unit may comprise at least one wheel unit, the wheel unit may comprise two wheel filters, the wheel filters may be circular plates, and comprise a plurality of filters arranged in a circular shape on an edge portion thereof, and each of the plurality of filters may allow light of a different wavelength to be passed through it.

The wheel filter may further comprise a blank slot not comprising a filter on the edge portion.

The step of passing light having a specific wavelength in the specific wavelength band of the light radiated from the light source may comprise: independently rotating each of the two wheel filters of the filter unit; and, selecting, in each of the two wheel filters, the blank slot or any one of the plurality of filters through which the light is to be passed. When any one of the plurality of filters is selected in the wheel filter, the step of passing light may comprise rotating the filter such that an incident angle of the light with respect to the filter is adjusted, wherein light of a different wavelength band may be passed through the filter depending on the incident angle of the light.

The incident angle of the light with respect to the filter may be equal to or greater than 0° and less than 90°.

The object may be a semiconductor wafer, the first wavelength may be included in a wavelength band of ultraviolet rays or visible rays, and the second wavelength may be included in a wavelength band of near infrared rays.

The light source for radiating light having ultra-wideband wavelengths may be a lamp or a laser.

The detection unit may be an image sensor capable of detecting visible rays, near infrared rays, and short wave infrared rays.

### Effect of the Invention

According to the present invention, since the spectral imaging inspection system comprises a light source having a wide wavelength band, a filter unit for selecting light having a specific wavelength in the wide wavelength band, and a detection unit for detecting light over the wide wavelength band, various pieces of information on an object can be obtained by just one spectral imaging inspection system.

Other objects and features will be in part apparent and in part pointed out hereinafter.

### BRIEF DESCRIPTION OF THE DRAWINGS

FIG. 1 is a drawing illustrating a path of light in the spectral imaging inspection method and system of the present invention.

FIG. 2 is a drawing illustrating the wheel units of the present invention.

FIG. 3 is a drawing illustrating an example of a multi-wheel filter system of the present invention and a path of light in the multi-wheel filter system.

FIG. 4 is a drawing illustrating another example of a multi-wheel filter system of the present invention and a path of light in the multi-wheel filter system.

FIGS. 5(a) and 5(b) illustrate the result of see-through inspection of the inside of a semiconductor wafer using the spectral imaging inspection method and system of the present invention.

FIGS. 6(a) and 6(b) illustrate the result of appearance inspection of a semiconductor wafer using the spectral imaging inspection method and system of the present invention.

FIGS. 7(a) to 7(j) are drawings illustrating the results of experiments in which light of a desired wavelength is selected from a wide wavelength band using the filter unit of the present invention.

Corresponding reference characters indicate corresponding parts throughout the drawings.

### DETAILED DESCRIPTION

Hereinafter, preferred examples of the present invention are described in detail with reference to the drawings. Advantages and features of the present invention and methods of achieving them will be made clear with reference to the examples described in detail below together with the drawings attached. However, the present invention is not limited to the examples described below, but may be implemented in various different forms. The examples are provided so that the disclosure of the present invention is complete and the scope of the present invention is fully known to a person having ordinary skill in the art to which the present invention belongs, and the present invention is defined only by the scope of the claims. An identical reference numeral refers to an identical constitutional element throughout the specification.

Unless otherwise defined, all terms (including technical and scientific terms) used herein have the meaning commonly understood by persons having ordinary skill in the art to which the present invention belongs. In addition, terms defined in commonly used dictionaries are not interpreted ideally or excessively unless they are clearly and specifically defined.

The terms used herein are for the purpose of describing examples and are not intended to limit of the present invention. In the present specification, a singular form includes a plural form unless specifically mentioned. The expression ‘comprise’ used herein does not exclude the presence or addition of one or more constitutional elements other than the mentioned constitutional element.

Hereinafter, spectral imaging inspection method and system according to examples of the present invention will be described with reference to the drawings.

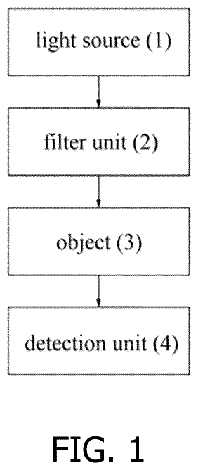

FIG. 1 is a drawing illustrating a path of light in the spectral imaging inspection method and system of the present invention. Light is radiated from a light source (1) and is passed through a filter unit (2). The light then reaches an object (3) to be reflected or penetrate the object to reach a detection unit.

The spectral imaging inspection system of the present invention comprises a holding unit for holding an object. The object of the present invention may be a semiconductor wafer or various electric/electronic products. Further, the holding unit may be a wafer support plate or table. However, it is not limited thereto, and the holding unit of the present invention comprises any feature capable of holding or supporting the object.

The spectral imaging inspection system of the present invention comprises a tunable light source unit. The tunable light source unit comprises a light source and a filter unit.

The light source of the tunable light source unit according to the present invention radiates light having a specific wavelength band. The specific wavelength band includes a first wavelength, a second wavelength, and a third wavelength. The range of the first wavelength of the present invention may be selected so that light having a wavelength included in the first wavelength is reflected by the object. Also, the range of the second wavelength of the present invention may be selected so that light having a wavelength included in the second wavelength partially penetrates the object. The range of the third wavelength of the present invention may be selected so that light having a wavelength included in the third wavelength penetrates the object.

The light partially penetrating the object means that while part of the light penetrates the object, the other part of the light is reflected by the object. That is, the light partially penetrating the object means that the penetration rate of the light for the object is greater than 0% and less than 100%. For example, the light partially penetrating the object according to the present invention may mean that the penetration rate of the light is 30%.

In an example of the present invention, the object may be a semiconductor wafer. Since a semiconductor wafer has a band-gap of 1.1 eV, visible rays do not penetrate a semiconductor wafer, and short wavelength infrared (SWIR) rays having a wavelength of 1000 nm or more may penetrate a semiconductor wafer. Using such short wavelength infrared rays, see-through inspection of the inside of a semiconductor wafer may be carried out. In addition, near infrared rays having a wavelength of 700 to 1000 nm may partially penetrate a semiconductor wafer. For example, the first wavelength of the present invention may be included in a wavelength band of ultraviolet rays of 200 to 400 nm or a wavelength band of visible rays of 400 to 600 nm, the second wavelength may be included in a wavelength band of near infrared rays of 700 to 1000 nm, and the third wavelength may be included in a wavelength band of short wavelength infrared rays of 1000 nm or more. However, the specific wavelength ranges of the first wavelength, the second wavelength, and the third wavelength may be appropriately modified according to the physical characteristics or properties of the object.

That is, the light source of the present invention may radiate light having ultra-wideband wavelengths in the range of, for example, 200 nm to 2.5 μm. The light source for radiating light having ultra-wideband wavelengths according to the present invention may be, for example, a lamp or a laser, but is not limited thereto, and comprises any feature capable of radiating light having wavelengths of a wide band.

The filter unit of the tunable light source unit according to the present invention may allow light having a specific wavelength in the specific wavelength band of the light radiated from the light source to be passed through it. The specific wavelength may be a wavelength included in the wavelength band of any one of the first wavelength, the second wavelength, and the third wavelength.

The filter unit of the present invention is provided with a multi-wheel filter system in order to select light having a desired wavelength in a wide wavelength band because the light source radiates light having a wide wavelength band.

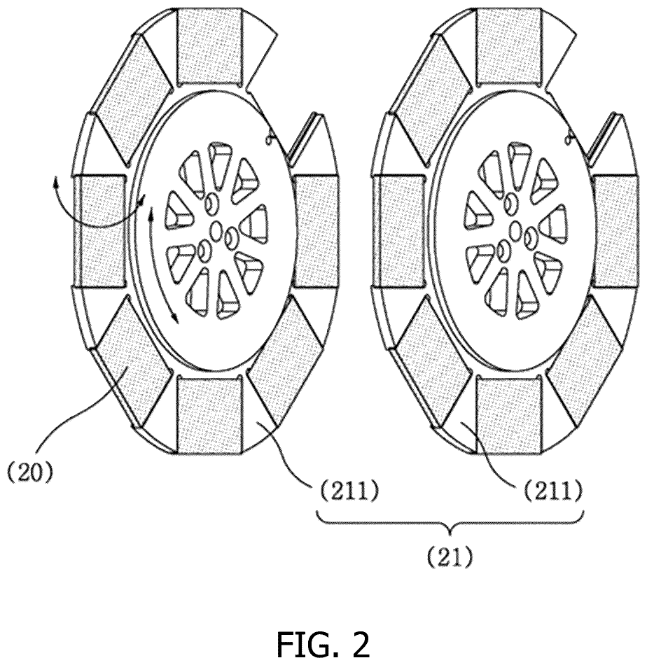

Specifically, referring to FIG. 2, the filter unit 21 of the present invention comprises at least one wheel unit. The wheel unit 21 may comprise two wheel filters 211, 212. Each of the wheel filters 211, 212 is a circular plate and comprises a plurality of filters 20 arranged in a circular shape on an edge portion thereof, and each of the plurality of filters 20 may allow light of a different wavelength band to be passed through it.

In addition, the wheel filter of the present invention may further comprise a blank slot not comprising a filter on the edge portion thereof. When the light is passed through the blank slot, the light is passed through the blank slot as it is without being filtered. In addition, the filter unit of the present invention may further comprise a compensator. The compensator plays a role of adjusting a path of light changed by the light passed through the plurality of filters to be identical to a path of the light before being passed through the plurality of filters.

The wheel filters 211, 212 of the present invention are rotatable, and each of the plurality of filters 20 may be rotated independently. The wheel filters and each of the plurality of filters of the wheel filters may be rotated manually or by a motor. The spectral imaging inspection system of the present invention comprises a control unit, wherein the control unit may transmit one or more commands or codes which can be read and/or executed by a computer to a motor unit, and the motor unit having received the command of the control unit may cause the wheel filters and the plurality of filters to rotate independently. That is, the rotation of the wheel filters and the plurality of filters may be implemented by software.

By independent rotation of each of the two wheel filters of the filter unit according to the present invention, any one of the plurality of filters provided on the edge portion thereof may be selected, or the blank slot provided on the edge portion thereof may be selected. In addition, by rotation of a filter of the wheel filter, an incident angle of the light with respect to the filter may be adjusted. Depending on the incident angle of the light with respect to the filter, a different wavelength of the light passed through the filter may be selected. That is, in the present invention, each of the wheel filters of the wheel unit is rotated so that any one of the plurality of filters or the blank slot is selected, and the filters of the wheel filter are rotated so that light having a desired wavelength is selected depending on an incident angle of the light with respect to a filter, thereby selecting light having a desired wavelength in the ultra-wideband wavelengths of the light from the light source. As a result, by selecting a desired wavelength from the wavelength band reflected by the object, the wavelength band partially penetrating the object, and the wavelength band penetrating the object that the light radiated from the light source has, and by radiating the light having the selected wavelength to the object, the present invention makes it possible to select desired information from various pieces of information on the object. That is, unlike the conventional art, the present invention allows obtaining various pieces of information on an object using light having a wavelength band of 1000 nm or more at a low cost and with a simple configuration, without safety equipment and experts.

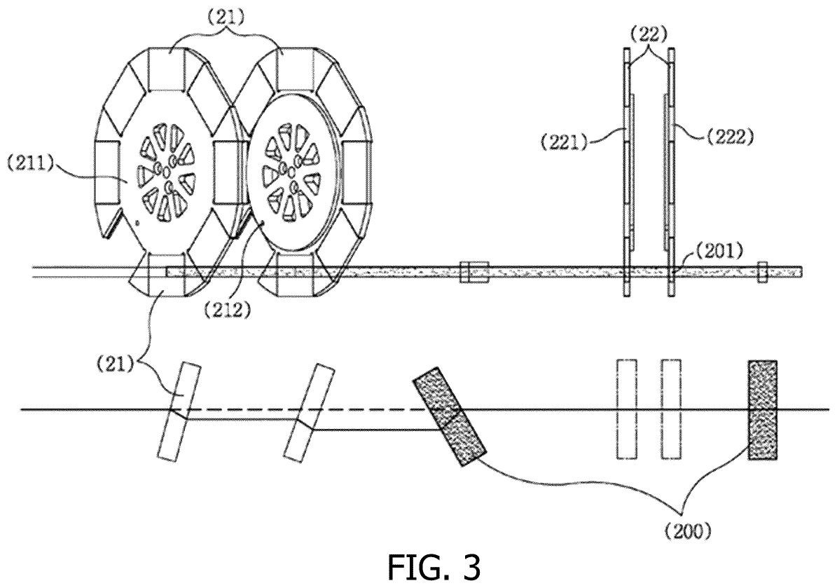

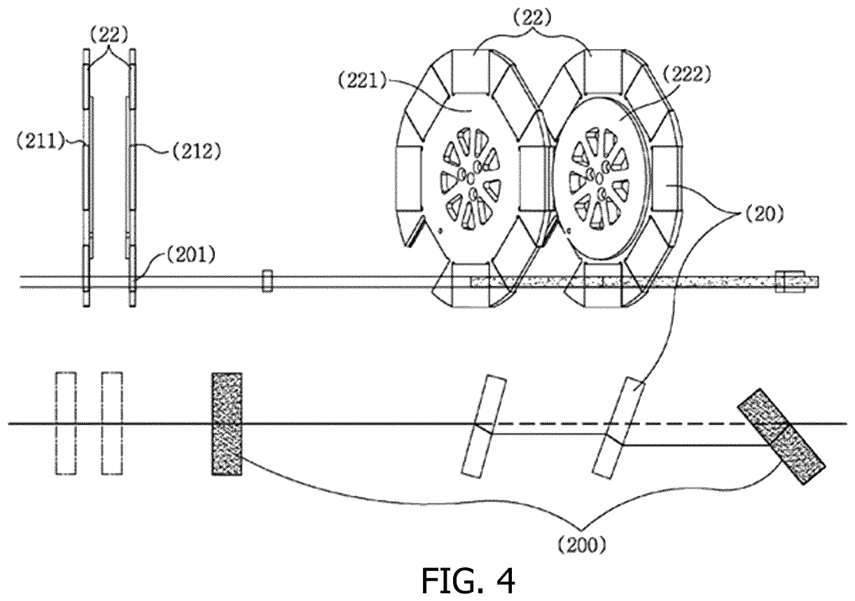

Hereinafter, the structure of the filter unit and the mechanism for selecting light having a specific wavelength from the light having ultra-wideband wavelengths according to the present invention will be described with reference to FIGS. 3 and 4.

First, FIG. 3 illustrates an example of a multi-wheel filter system of the present invention and a path of light in the multi-wheel filter system. The filter unit of the present invention may comprise at least one wheel unit. For example, the filter unit of the present invention may comprise a first wheel unit 21 and a second wheel unit 22. Each of the first wheel unit 21 and the second wheel unit 22 may comprise a first wheel filter and a second wheel filter.

For example, it may be assumed that the first wheel unit 21 is provided with, on the edge thereof, filters 20 for allowing light having a wavelength of 400 to 1000 nm to be passed through them, and the second wheel unit 22 is provided with filters 20 for allowing light having a wavelength of 1001 to 1700 nm to be passed through them.

In this case, using the filter unit of the present invention, it is possible to select, for example, light having a center wavelength of 500 nm from the wide wavelength band of the light radiated from the light source. Specifically, referring to FIG. 3, the motor unit, following a command of the control unit, may rotate the first wheel filter 211 and the second wheel filter 212 so that the first wheel unit 21 allows light having a specific wavelength width with the center wavelength of 500 nm to be passed through it, whereby a filter 20 of the first wheel filter 211 and a filter 20 of the second wheel filter 212 for allowing light having a specific wavelength width with the center wavelength of 500 nm to be passed through them may be selected. The filter 20 of the first wheel filter 211 and the filter 20 of the second wheel filter 212 may then be rotated such that the light passed through the filters has desired center wavelength and wavelength width. The light radiated from the light source is passed through the filter (20) of the first wheel filter (211) and the filter (20) of the second wheel filter (212), whereby the light passed through the first wheel unit (21) has only a specific wavelength width with the center wavelength of 500 nm. That is, the present invention may set the center wavelength and the wavelength width of light passed through the wheel unit to a desired value by combining the filters of the first wheel filter and the second wheel filter. In addition, the light passed through the first wheel unit 21 may be adjusted, by the compensator 200 of the filter unit, to have a path of the light before being passed through the first wheel unit 21.

On the other hand, since the second wheel unit 22 is provided with filters 20 for allowing light having a wavelength of 1001 to 1700 nm to be passed through them, in order to allow light having a center wavelength of 500 nm to be passed, the motor unit, by a command of the control unit, may rotate the first wheel filter 221 and the second wheel filter 222 so that the light passed through the first wheel unit 21 is passed through the empty slots 201 provided in the first wheel filter 221 and the second wheel filter 222 of the second wheel unit 22. That is, light passed through the first wheel unit 21 that has a center wavelength of 500 nm is passed through the second wheel unit 22 as it is. As described above, using the filter unit of the present invention, it is possible to select, for example, light having a center wavelength of 500 nm from the ultra-wideband wavelength band of the light radiated from the light source.

FIG. 4 is a drawing illustrating another example of a multi-wheel filter system of the present invention and a path of light in the multi-wheel filter system. As in FIG. 3, it may be assumed, for example, that the first wheel unit 21 is provided with, on the edge thereof, filters 20 for allowing light having a wavelength of 400 to 1000 nm to be passed through them, and the second wheel unit 22 is provided with filters 20 for allowing light having a wavelength of 1001 to 1700 nm to be passed through them.

In this case, using the filter unit of the present invention, it is possible to select, for example, light having a center wavelength of 1300 nm from a wide wavelength band of the light radiated from the light source. Specifically, referring to FIG. 4, since the first wheel unit 21 is provided with filters 20 for allowing light having a wavelength of 400 to 1000 nm to be passed through them, for the purpose of allowing light having a center wavelength of 1300 nm to be passed, the motor unit, by a command of the control unit, may rotate the first wheel filter 211 and the second wheel filter 212 by rotating the first wheel unit 21 so that the light radiated from the light source 1 is passed through the first wheel filter 211 of the first wheel unit 21 and the blank slot 201 provided in the second wheel filter 212. That is, the light radiated from the light source 1 is passed through the first wheel unit 21 as it is and is incident on the second wheel unit 22.

On the other hand, following a command of the control unit, the motor unit may rotate the first wheel filter 221 and the second wheel filter 222 so that the second wheel unit 22 allows light having a specific wavelength width with the center wavelength of 1300 nm to be passed through it, whereby a filter 20 of the first wheel filter 221 and a filter 20 of the second wheel filter 222 for allowing light having a specific wavelength width with the center wavelength of 1300 nm to be passed through them may be selected. Then, the filter 20 of the first wheel filter 221 and the filter 20 of the second wheel filter 222 may be rotated so that the light passed through the filters has desired center wavelength and wavelength width. The light passed through the first wheel unit 21 is passed through the filter 20 of the first wheel filter 221 and the filter 20 of the second wheel filter 222, whereby the light passed through the second wheel unit 22 has only a specific wavelength width with the center wavelength of 1300 nm. In addition, the light passed through the second wheel unit 22 may be adjusted, by the compensator 200 of the filter unit, to have a path of the light before being passed through the second wheel unit 22. Accordingly, using the filter unit 2, it is possible to select, for example, light having a center wavelength of 1300 nm from the ultra-wideband wavelength band of the light radiated from the light source 1.

Although not shown in the drawings, the wheel filters, the plurality of filters of the wheel filters, and the compensator may be connected to a control device such as a computer comprising a memory and a processor, and the processor may calculate a rotation angle of the wheel filters, a rotation angle of the plurality of filters for deriving a desired wavelength band, and parameters of the compensator for adjusting the path of the light, and store the calculated values in the memory.

The detection unit of the present invention detects an image of an object with respect to a specific wavelength of the light passed through the filter unit and radiated to the object. The detection unit of the present invention may be a wideband image sensor, but is not limited thereto. The detection unit of the present invention may be an image sensor capable of detecting light of all of the first wavelength, the second wavelength, and the third wavelength. For example, the detection unit may be Sony's IMX 990, IMX 991, or the like, and may be a sensor using quantum dots.

In another example of the present invention, the detection unit may comprise one or more image sensors. The detection unit may be provided with image sensors for detecting images of an object with respect to different wavelength bands, and any one of the image sensors may be selected depending on the wavelength of the light radiated to the object. In this case, an image sensor suitable for the wavelength of the light may be selected by the control unit and replaced automatically. This may be implemented in a way that the detection unit comprises the motor unit, and the control unit transmits a command to the motor unit.

In another example of the present invention, the detection unit may comprise a plurality of sensors. In this case, an optical splitter may be disposed at the detection unit. The light radiated from the light source and passed through the filter unit may be radiated to the object, and the light having penetrated the object or reflected by the object may be incident on the splitter. By the splitter, the light may be incident on any one of the plurality of sensors. The control unit may control the splitter depending on the sensor of the plurality of sensors to detect the light.

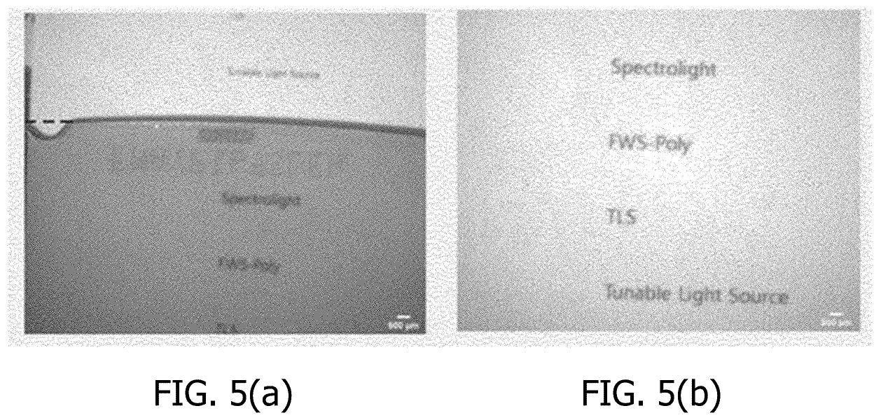

FIGS. 5(a) and 5(b) illustrates the result of see-through inspection of the inside of a semiconductor wafer using the spectral imaging inspection method and system of the present invention. FIG. 5(b) is a drawing illustrating printed letters. FIG. 5(a) is a drawing illustrating the result of see-through inspection of a semiconductor wafer where the semiconductor wafer is placed on printed letters and the spectral imaging inspection method and system of the present invention is used. Specifically, FIG. 5(a) illustrates the result of selecting light having a wavelength that penetrates a semiconductor wafer (SWIR) from the ultra-wideband wavelengths of the light radiated from the light source, radiating the selected light to the semiconductor wafer, and detecting an image of the semiconductor wafer with respect to the light using the detection unit. That is, with the spectral imaging inspection method and system of the present invention, information on the inside of a semiconductor wafer may be obtained.

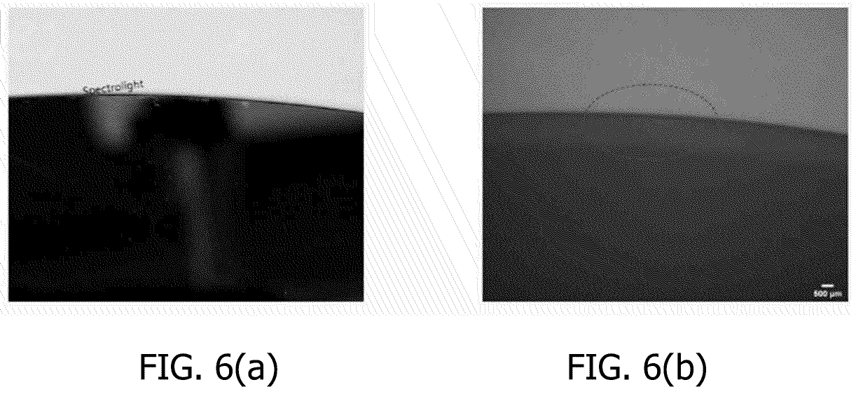

FIGS. 6(a) and 6(b) illustrate the result of appearance inspection of a semiconductor wafer using the spectral imaging inspection method and system of the present invention. FIG. 6(a) illustrates a semiconductor wafer placed on printed letters. FIG. 6(b) is a drawing illustrating the result of appearance inspection of a semiconductor wafer using the spectral imaging inspection method and system of the present invention in which the semiconductor wafer is placed on printed letters as in FIG. 6(a). Specifically, FIG. 6(a) illustrates the result of selecting light having a wavelength that is reflected by a semiconductor wafer (visible rays) from the ultra-wideband wavelengths of the light radiated from the light source, radiating the selected light to the semiconductor wafer, and detecting an image of the semiconductor wafer with respect to the light using the detection unit. That is, with the spectral imaging inspection method and system of the present invention, information on the outside of a semiconductor wafer may be obtained.

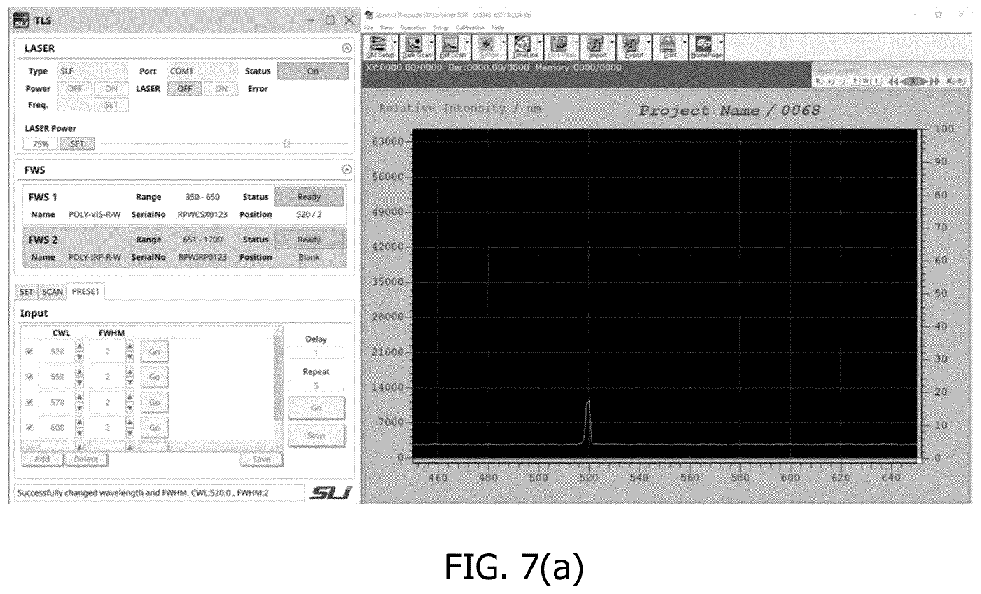

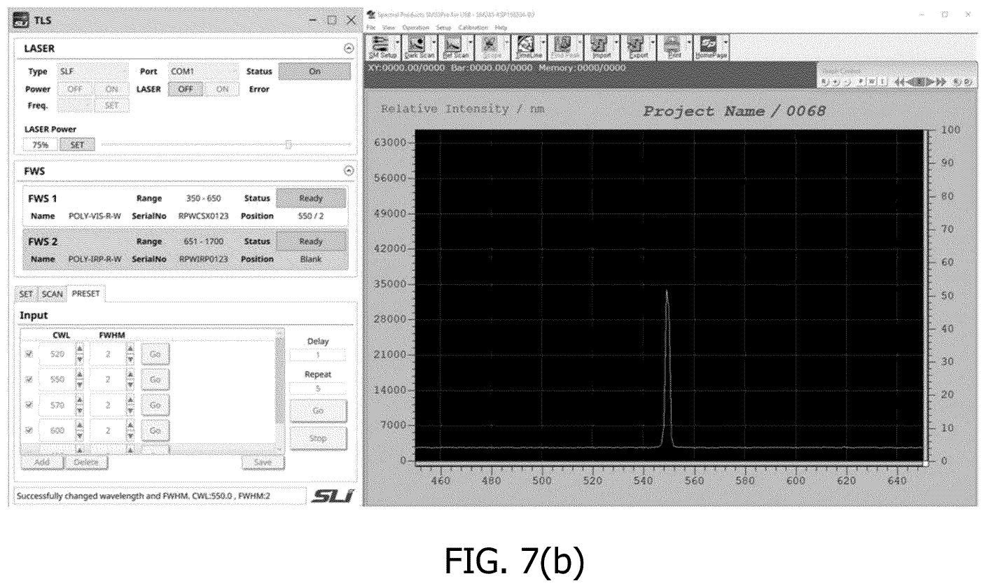

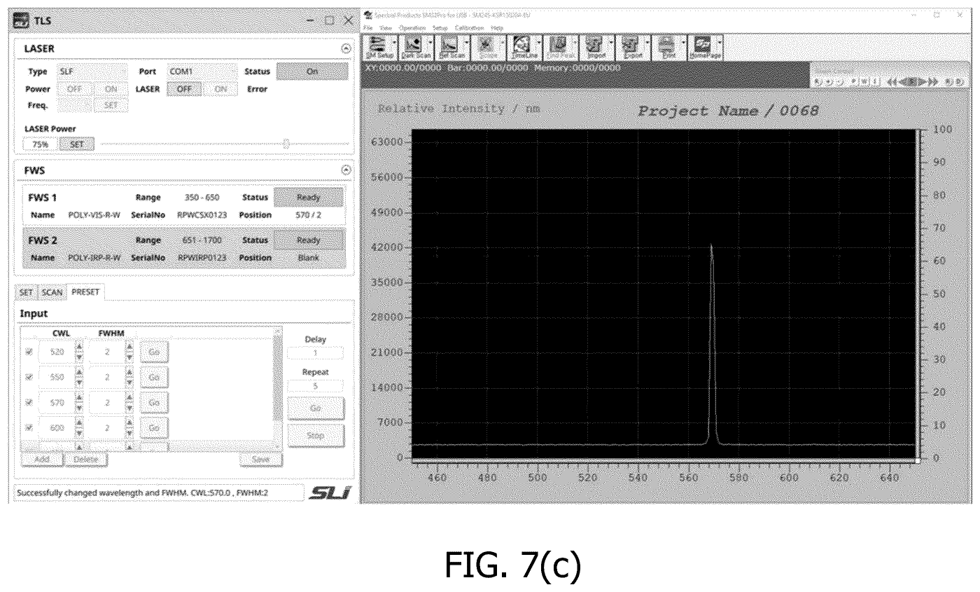

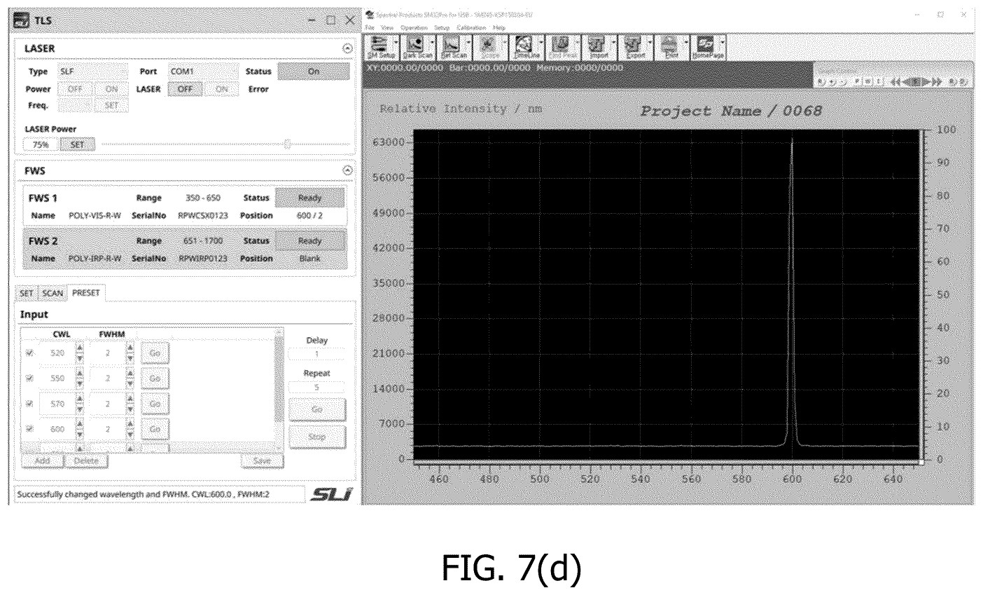

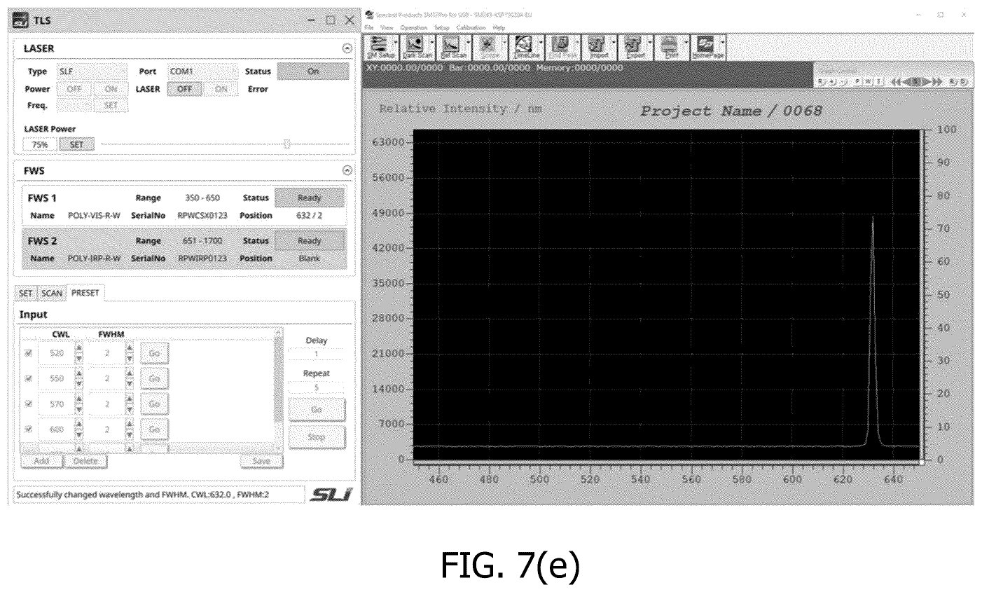

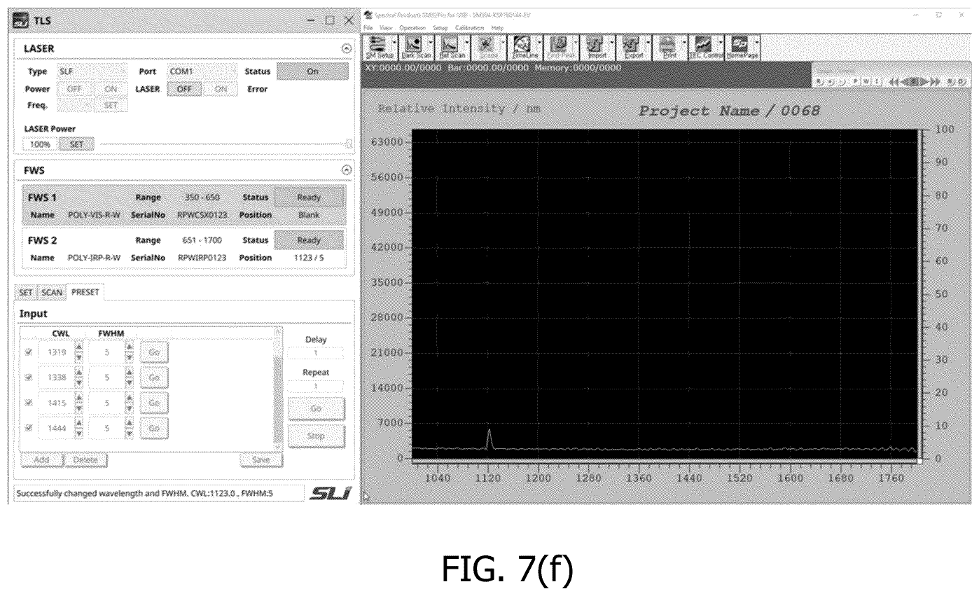

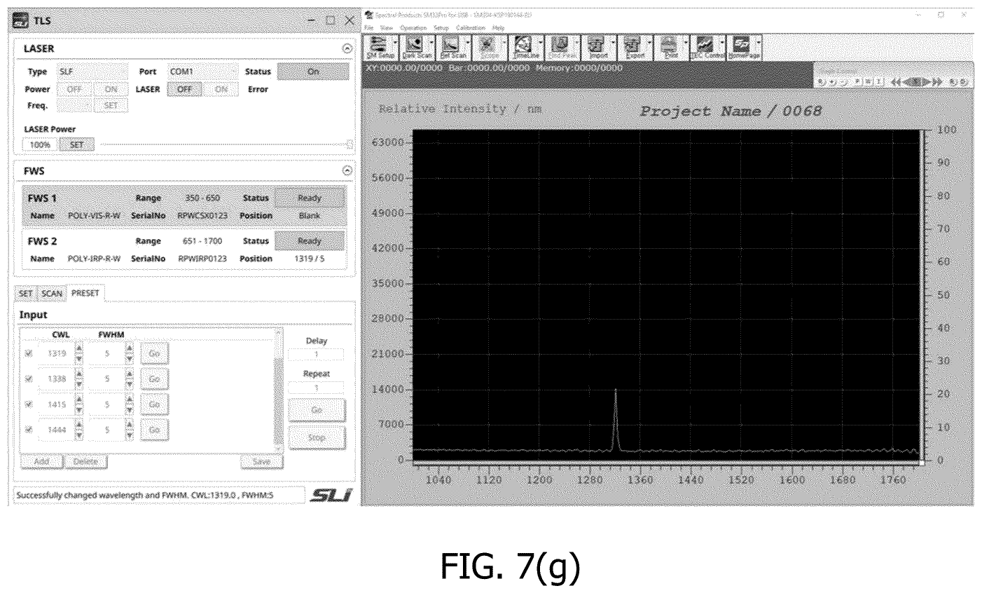

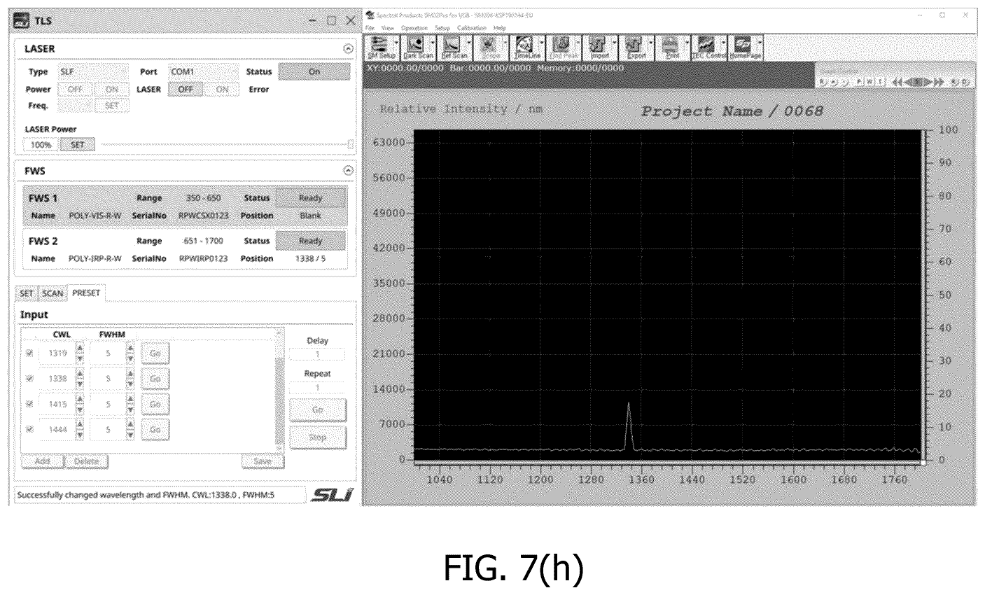

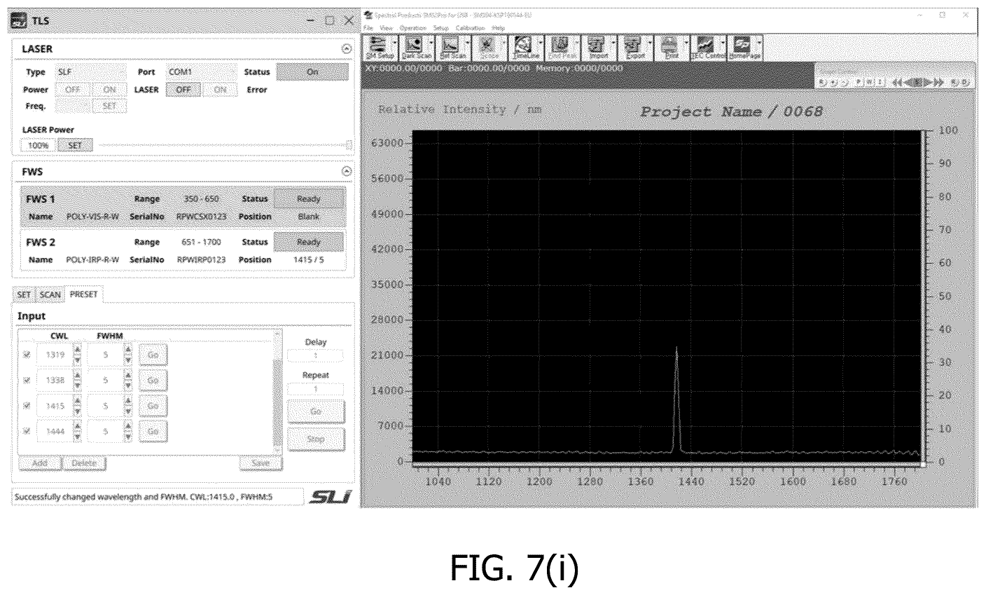

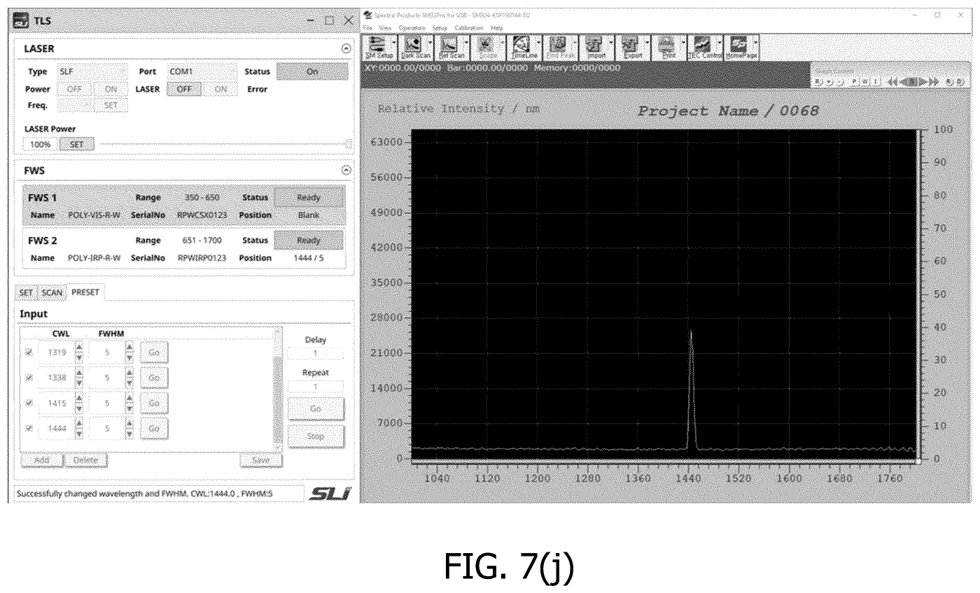

FIGS. 7(a) to 7(j) are drawings illustrating the results of experiments in which light of a desired wavelength is selected from a wide wavelength band using the filter unit of the present invention.

Specifically, in an example of the present invention, the first wheel unit of the present invention was configured to comprise a plurality of filters for allowing a wavelength of 350 to 650 nm to be passed through them, and the second wheel unit of the present invention was configured to comprise a plurality of filters for allowing a wavelength of 651 to 1700 nm to be passed through them. Then, the center and width of a desired wavelength were entered into the control unit of the present invention, after which the motor unit, following a command of the control unit, rotated to measure, using a spectrometer, the wavelength of the light passed through the selected filters or blank slot of the first wheel unit and the selected filters or blank slot of the second wheel unit. The left parts of FIGS. 7(a)-7(j) show software of the control unit, and the right parts show values obtained by measuring the wavelength of the light radiated from the light source and passed through the filter unit using a spectrometer.

FIG. 7(a) shows the result of an experiment where 520 nm and 2 nm are selected as desired center wavelength and wavelength width, respectively. When values of the desired center wavelength and wavelength width were entered into the control unit, following a command of the control unit, one of the filters of the first wheel filter and one of the filters of the second wheel filter were selected in the first wheel unit so that light having a center wavelength of 520 nm and a wavelength width of 2 nm is passed through the first wheel unit, and the empty slot of the first wheel filter and the second wheel filter was selected in the second wheel unit. The wavelength of the light radiated from the light source and passed through the filter unit was measured with a spectrometer, as a result of which the light having the desired central wavelength of 520 nm and the desired wavelength width of 2 nm was detected.

In the same manner as FIG. 7(a), FIG. 7(b) shows the result of an experiment where 550 nm and 2 nm are selected as desired center wavelength and wavelength width, respectively, FIG. 7(c) shows the result of an experiment where 570 nm and 2 nm are selected as desired center wavelength and wavelength width, respectively, FIG. 7(d) shows the result of an experiment where 600 nm and 2 nm are selected as desired center wavelength and wavelength width, respectively, and FIG. 7(e) shows the result of an experiment where 632 nm and 2 nm are selected as desired center wavelength and wavelength width, respectively. In all of the experiments of FIGS. 7(b) to 7(e), it was confirmed using a spectrometer that the light radiated from the light source and passed through the filter unit of the present invention had the desired center wavelength and wavelength width.

FIG. 7(f) shows the result of an experiment where 1123 nm and 5 nm are selected as desired center wavelength and wavelength width, respectively. When values of the desired center wavelength and wavelength width were entered into the control unit, following a command of the control unit, the blank slot of the first wheel filter and the blank slot of the second wheel filter were selected in the first wheel unit, and one of the filters of the first wheel filter and one of the filters of the second wheel filter were selected in the second wheel unit so that light having a center wavelength of 1123 nm and a wavelength width of 5 nm is passed through the second wheel unit. The wavelength of the light radiated from the light source and passed through the filter unit was measured with a spectrometer, as a result of which the light having the desired central wavelength of 1123 nm and the desired wavelength width of 5 nm was detected. In the same manner as FIG. 7(f), FIG. 7(g) shows the result of an experiment where 1319 nm and 5 nm are selected as desired center wavelength and wavelength width, respectively, FIG. 7(h) shows the result of an experiment where 1338 nm and 5 nm are selected as desired center wavelength and wavelength width, respectively, FIG. 7(i) shows the result of an experiment where 1415 nm and 5 nm are selected as desired center wavelength and wavelength width, respectively, and FIG. 7(j) shows the result of an experiment where 1444 nm and 5 nm are selected as desired center wavelength and wavelength width, respectively. In all of the experiments of FIGS. 7(g) to 7(j), it was confirmed using a spectrometer that the light radiated from the light source and passed through the filter unit of the present invention had the desired center wavelength and wavelength width.

As described above, using the filter unit of the present invention, it is possible to select a desired wavelength from the wide wavelength band of the light radiated from the light source. That is, with the spectral imaging inspection method and system of the present invention, it is possible to select light suitable for desired information such as the appearance and the inside of an object, thereby simultaneously obtaining, by one system, various pieces of information such as information on the appearance and the inside of an object being inspected.

A spectral imaging inspection method according to an example of the present invention comprises: holding an object in a holding unit; radiating, from a light source, light having a specific wavelength band; passing, through a filter unit, light having a specific wavelength in the specific wavelength band of the light radiated from the light source; and, detecting, with a detecting unit, an image of the object with respect to the specific wavelength of the light passed through the filter unit and radiated to the object. The specific wavelength band includes a first wavelength, a second wavelength, and a third wavelength, wherein the light of the first wavelength is reflected by the object, only part of the light of the second wavelength penetrates the object, and the light of the third wavelength penetrates the object, and the third wavelength is a wavelength band of short wave infrared rays of 1000 nm or more.

The filter unit may comprise at least one wheel unit, the wheel unit may comprise two wheel filters, the wheel filters may be circular plates, and comprise a plurality of filters arranged in a circular shape on an edge portion thereof, and each of the plurality of filters may allow light of a different wavelength to be passed through it.

The wheel filter may further comprise a blank slot not comprising a filter on the edge portion.

The step of passing light having a specific wavelength in the specific wavelength band of the light radiated from the light source may comprise: independently rotating each of the two wheel filters of the filter unit; and, selecting, in each of the two wheel filters, the blank slot or any one of the plurality of filters through which the light is to be passed. When any one of the plurality of filters is selected in the wheel filter, the step of passing light may comprise rotating the filter such that an incident angle of the light with respect to the filter is adjusted, wherein light of a different wavelength band may be passed through the filter depending on the incident angle of the light.

The incident angle of the light with respect to the filter may be equal to or greater than 0° and less than 90°.

The object may be a semiconductor wafer, the first wavelength may be included in a wavelength band of ultraviolet rays or visible rays, and the second wavelength may be included in a wavelength band of near infrared rays.

The light source for radiating light having ultra-wideband wavelengths may be a lamp or a laser.

The detection unit may be an image sensor capable of detecting visible rays, near infrared rays, and short wave infrared rays.

In an aspect, the present invention provides spectral imaging inspection method and system for selecting light having a specific wavelength in ultra-wideband wavelengths from which desired information can be obtained. A spectral imaging inspection system according to an example of the present invention comprises: a tunable light source unit, comprising a light source for radiating light having a specific wavelength band, and a filter unit for allowing light having a specific wavelength in the specific wavelength band of the light radiated from the light source to be passed through it; a holding unit for holding an object; and, a detection unit for detecting an image of the object with respect to the specific wavelength of the light passed through the filter unit and radiated to the object. The specific wavelength band includes a first wavelength, a second wavelength, and a third wavelength, wherein the light of the first wavelength is reflected by the object, only part of the light of the second wavelength penetrates the object, and the light of the third wavelength penetrates the object, and the third wavelength is a wavelength band of short wave infrared rays of 1000 nm or more.

### DESCRIPTION OF REFERENCE NUMERALS

1: light source
2: filter unit
3: object
4: detection unit
20: filter
21: first wheel unit
22: second wheel unit
200: compensator
201: blank slot
211: first wheel filter
212: second wheel filter
221: first wheel filter
222: second wheel filter

Although the examples of the present invention have been described as above with reference to the drawings attached, it will be understood by those skilled in the art that the present invention may be implemented in other specific forms without departing from the technical idea or essential features thereof. Therefore, it should be understood that the examples described above are exemplary and not restrictive in all aspects.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A spectral imaging inspection system, comprising:
a tunable light source unit, comprising
a light source for radiating light having a specific wavelength band, and
a filter unit for allowing light having a specific wavelength in the specific wavelength band of the light radiated from the light source to be passed through it;
a holding unit for holding an object; and,
a detection unit for detecting an image of the object with respect to the specific wavelength of the light passed through the filter unit and radiated to the object,
wherein the specific wavelength band includes a first wavelength, a second wavelength, and a third wavelength,
wherein the light of the first wavelength is reflected by the object, only part of the light of the second wavelength penetrates the object, and the light of the third wavelength penetrates the object, and
wherein the third wavelength is a wavelength of short wave infrared rays of 1000 nm or more.

2. The spectral imaging inspection system according to claim 1,
wherein the filter unit comprises at least one wheel unit,
wherein the wheel unit comprises two wheel filters,
wherein the wheel filters are circular plates, and comprise a plurality of filters arranged in a circular shape on an edge portion thereof, and
wherein each of the plurality of filters allows light of a different wavelength to be passed through it.

3. The spectral imaging inspection system according to claim 2,
wherein the wheel filter further comprises a blank slot not comprising a filter on the edge portion.

4. The spectral imaging inspection system according to claim 3,
wherein, for the purpose of allowing a specific wavelength in the specific wavelength band of the light radiated from the light source to be passed through the filter unit,
each of the two wheel filters of the filter unit independently rotates to select, in each of the two wheel filters, the blank slot or any one of the plurality of filters through which the light is to be passed, and
when any one of the plurality of filters is selected in the wheel filter, the filter is capable of rotating such that an incident angle of the light with respect to the filter is adjusted, wherein light of a different wavelength is passed through the filter depending on the incident angle of the light.

5. The spectral imaging inspection system according to claim 4,
wherein the incident angle of the light with respect to the filter is equal to or greater than 0° and less than 90°.

6. The spectral imaging inspection system according to claim 1,
wherein the object is a semiconductor wafer.

7. The spectral imaging inspection system according to claim 1,
wherein the first wavelength is included in a wavelength band of ultraviolet rays or visible rays, and
wherein the second wavelength is included in a wavelength band of near infrared rays.

8. The spectral imaging inspection system according to claim 1,
wherein the light source for radiating light having ultra-wideband wavelengths is a lamp or a laser.

9. The spectral imaging inspection system according to claim 1,
wherein the detection unit is an image sensor capable of detecting visible rays, near infrared rays, and short wave infrared rays.

10. A spectral imaging inspection method, comprising:
holding an object in a holding unit;
radiating, from a light source, light having a specific wavelength band;
passing, through a filter unit, light having a specific wavelength in the specific wavelength band of the light radiated from the light source; and,
detecting, with a detecting unit, an image of the object with respect to the specific wavelength of the light passed through the filter unit and radiated to the object,
wherein the specific wavelength band includes a first wavelength, a second wavelength, and a third wavelength,
wherein the light of the first wavelength is reflected by the object, only part of the light of the second wavelength penetrates the object, and the light of the third wavelength penetrates the object, and
wherein the third wavelength is a wavelength of short wave infrared rays of 1000 nm or more.

11. The spectral imaging inspection method according to claim 10,
wherein the filter unit comprises at least one wheel unit,
wherein the wheel unit comprises two wheel filters,
wherein the wheel filters are circular plates, and comprise a plurality of filters arranged in a circular shape on an edge portion thereof, and
wherein each of the plurality of filters allows light of a different wavelength to be passed through it.

12. The spectral imaging inspection method according to claim 11,
wherein the wheel filter further comprises a blank slot not comprising a filter on the edge portion.

13. The spectral imaging inspection method according to claim 12,
wherein the step of passing light comprises:
independently rotating each of the two wheel filters of the filter unit; and,
selecting, in each of the two wheel filters, the blank slot or any one of the plurality of filters through which the light is to be passed, and,
when any one of the plurality of filters is selected in the wheel filter, the step of passing light further comprises
rotating the filter such that an incident angle of the light with respect to the filter is adjusted, wherein light of a different wavelength is passed through the filter depending on the incident angle of the light.

14. The spectral imaging inspection method according to claim 13,
wherein the incident angle of the light with respect to the filter is equal to or greater than 0° and less than 90°.

15. The spectral imaging inspection method according to claim 10,
wherein the object is a semiconductor wafer.

16. The spectral imaging inspection method according to claim 10,
wherein the first wavelength is included in a wavelength band of ultraviolet rays or visible rays, and
wherein the second wavelength is included in a wavelength band of near infrared rays.

17. The spectral imaging inspection method according to claim 10,
wherein the light source for radiating light having ultra-wideband wavelengths is a lamp or a laser.

18. The spectral imaging inspection method according to claim 10,
wherein the detection unit is an image sensor capable of detecting visible rays, near infrared rays, and short wave infrared rays.
